(19) United States
(12) Patent Application Publication
(10) Pub. No.: US 2007/0287028 A1
(43) Pub. Date: Dec. 13, 2007

(54) SELF-ILLUMINATING GLAZING PANELS

(76) Inventors: Wilfried Hedderich, Hilden (DE); Christophe Lefaux, Ann Arbor, MI (US)

Correspondence Address: EXATEC;C/O BRINKS HOFER GILSON & LIONE, P. O. BOX 10395, CHICAGO, IL, 60610, US

(21) Appl. No.: 11/423,319

(22) Filed: Jun. 9, 2006

(51) Int. Cl. B32B 19/00

(52) U.S. Cl. 428/690

(57) ABSTRACT

A self-illuminating glazing panel suitable for use in an automotive vehicle is provided for better night and dusk visibility for safety purposes and for brighter appearance during the day. The self-illuminating glazing panel integrates a luminescent layer, containing phosphorescent or fluorescent pigments or dyes, with a plastic substrate. The luminescent layer allows the panel to glow during the evening and night hours upon excitation by external light sources, such as headlamps and streetlights.

### BACKGROUND OF THE INVENTION

1. Field of the Invention

The present invention relates to a plastic glazing panel for use as an automotive window. More specifically, the invention relates to a self-illuminating glazing panel that integrates a layer of luminescent ink comprising a phosphorescent or a fluorescent pigment with a polymeric substrate.

2. Background of the Invention

Plastic materials are used for manufacturing various automotive parts and components such as B-Pillars, headlamps, and various panels. Some plastic materials, such as polycarbonate, offer superior resistance to fracture and/or dislodgement in case of accidents and hence may be used as glazing panels for the windows and sunroofs of automotive vehicles. Plastic materials give more freedom in the style and shape of the glazing panel which in effect provides significant freedom in regards to the design of an automotive window. Furthermore, plastic materials may be combined with coating systems to add different functionalities to the glazing panels.

It currently has become popular with the end-user to use colored and illuminating bands in conjunction with glass window panels for both styling and safety purposes. A bright band on a vehicle's window helps increase the visibility of the vehicle to other motorists and pedestrians. The enhanced visibility of such vehicles assists in significantly reducing side and rear-end collisions. Vehicles with bright-banded windows may play a crucial role in avoiding accidents during the evening and night hours.

The illuminated bands or strips that may be attached to a car's window or body for decorative or safety purposes are essentially an after-market product. These illuminating bands are typically neither integrated as part of the car body or in the window glazing system. Aftermarket products, such as these illuminating bands, are usually expensive and not tested to meet or maintain the stringent performance conditions required for automotive original equipment.

Therefore, there is a need for an integrated colored and/or illuminated band into the automotive glazing system in order to insure that there are no detrimental performance effects and to minimize the cost of such a component to the end-user.

### SUMMARY

The present invention is directed to a self-illuminating glazing panel suitable for use in an automotive vehicle that provides aesthetic acceptance and better visibility during the night for safety purposes. In one embodiment of the present invention, the self-illuminating glazing panel comprises a plastic substrate, a luminescent layer disposed on the plastic substrate, a weatherable layer affixed to the luminescent layer for reducing the amount of infrared and ultraviolet radiation penetrating into the underlying plastic substrate, and an abrasion resistant layer capable of resisting abrasion upon exposure to external elements.

Another embodiment of the present invention provides a method for manufacturing a self-illuminating glazing panel. The method comprises forming a self-illuminating glazing panel by molding a plastic substrate from a polymeric resin and printing a layer of luminescent material on the molded plastic substrate. The method further comprises depositing at least one weatherable layer onto the surface of the plastic panel; and depositing at least one abrasion layer onto the weathering layer(s), the abrasion layer providing abrasion resistance to the outwardly facing surfaces of the glazing panel.

The luminescent layer is integrated with the glazing panel so that the glazing panel glows due to excitation from external light sources during the night, such as head lamps from another vehicle. The glazing panel is preferably self-illuminating and is capable of producing luminescence without requiring any external electrical power source, as is required for electroluminescent materials.

Automotive safety is one advantage that a self-illuminating glazing panel of the present invention provides by increasing the visibility of the vehicle to other motorists and pedestrians. This in turn may play a crucial role in avoiding accidents during the evening and night hours. A second advantage of the present invention is that a luminescent layer, when integrated with the glazing panel, may give a brighter appearance to the windows or sunroofs during the daylight hours. This effect may enhance the aesthetic appearance of the vehicle to the end-user.

These and other features, aspects, and advantages of the present invention will become better understood with reference to the following description and appended claims.

### BRIEF DESCRIPTION OF THE DRAWINGS

In the drawings, the same or similar reference numbers identify similar elements.

FIG. 1 is a partial perspective view of an automotive vehicle incorporating a self-illuminating glazing panel according to the principles of the present invention.

FIG. 2 is a cross-sectional schematic illustration of a self-illuminating glazing panel according to the present invention wherein a luminescent layer is printed on a plastic substrate.

FIGS. 3A and 3B are cross-sectional schematic illustrations of alternative embodiments of the present invention wherein the self-illuminating glazing panel includes a plastic film integrated with the self-illuminating glazing panel using a film insert molding (FIM) technique.

FIG. 4 is a block diagram showing a process for manufacturing the self-illuminating glazing panel according to another aspect of the present invention.

FIG. 5 is a block diagram showing an alternative embodiment for the process of manufacturing the self-illuminating glazing panel according to the principles of the present invention.

### DETAILED DESCRIPTION OF THE INVENTION

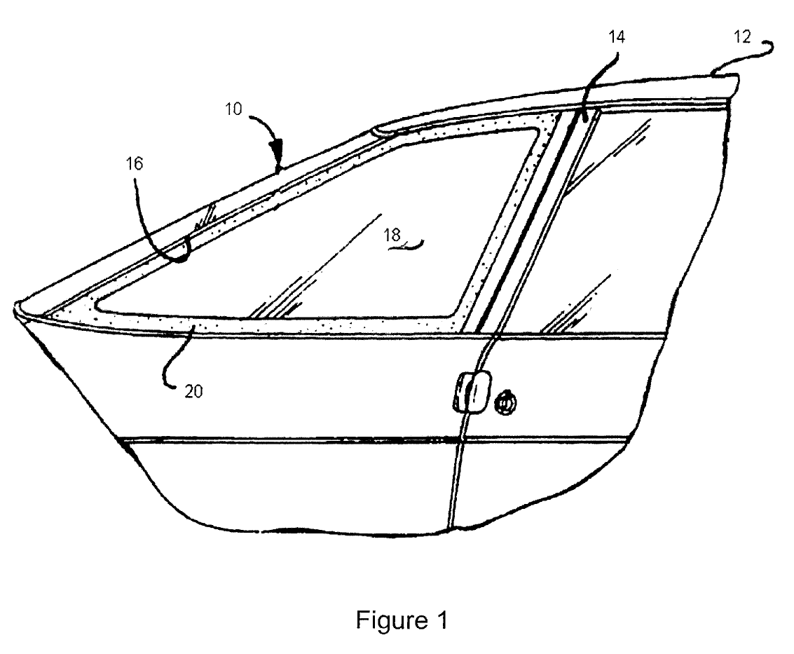

FIG. 1 shows a portion of an automotive vehicle 10 comprising a body 12 having portions 14, 16 defining a rear quarter window opening in which a self-illuminating glazing panel 18, according to the present invention, is fixed in the conventional fashion, such as with adhesive bonding. A masking body 20 is preferably provided to conceal the adhesive joint.

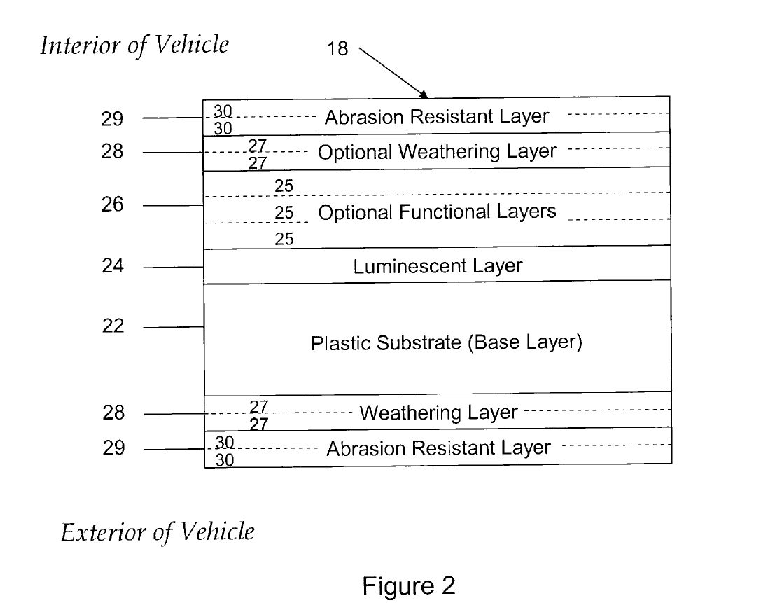

FIG. 2 diagrammatically illustrates a cross-sectional view of one embodiment of the self-illuminating glazing panel 18 of the present invention. As shown, the glazing panel 18 comprises multiple layers integrally formed with a plastic substrate 22, which is a transparent plastic panel having good optical clarity. The plastic substrate 22 forms the base layer for glazing panel 18. A luminescent layer 24, printed on plastic substrate 22, provides a self-illuminating characteristic to the glazing panel 18. Additionally, an optional functional layer 26 may be printed or deposited on the luminescent layer 24 using any standard technique known to those skilled in the art. The optional functional layer 26 may be comprised of a single layer or multiple sub-layers 25, with each sub-layer providing a different functionality. For example, one sub-layer 25 may comprise a decorative border (such as the masking body 20 mentioned previously), while a second sub-layer 25 may comprise a heater grid for defrosting the window. The luminescent layer 24 and the optional functional layer 26 are placed on the interior surface of the plastic substrate, which is the surface located to the inside of the automotive vehicle 10. Overlaid on the exterior side of the plastic substrate 22, is a weatherable layer 28 that blocks the transmission of ultraviolet radiation, thereby preventing any harmful effects of the radiation on the underlying layers. A second weatherable layer 28′ may be optionally provided on the interior of the vehicle. This layer 28′ is optional because the interior surface of the glazing panel interacts with substantially less sunlight than the exterior surface of the glazing panel. An abrasion resistant layer 28 forms the outermost layer of the self-illuminating glazing panel, over the weatherable layer 29, and provides an additional degree of protection for the self-illuminating glazing panel from abrasion, moisture, and other external elements. As with the second weatherable layer 28′, a second abrasion layer 29′ may be provided on the interior of the glazing panel 18.

Preferably, the plastic substrate 22 is transparent. However, it may in some instances be translucent, opaque or a combination of these. The plastic substrate 22 can be formed of a variety of different thermoplastic or thermoset polymeric resins known to those skilled in the art. These polymeric resins include, but are not limited to, polycarbonate, acrylic, polyacrylate, polyester, polysulfone, polyurethane, silicone, epoxy, polyamide, polyalkylenes, acrylonitrile-butadiene-styrene (ABS) as well has copolymers, blends, and mixtures thereof. The plastic substrate 22 may further include various additives such as colorants, Theological control agents, mold release agent, antioxidants, ultraviolet absorbing (UVA) molecules, and infrared (IR) absorbing or reflecting pigments, among others.

The luminescent layer 24 comprises a phosphorescent or fluorescent ink that is capable of producing luminescence after absorbing radiant energy or other type of energy. The luminescent layer 24 may be a band, strip, border, or decorative pattern applied by screen printing, inkjet printing, mask & spray, or any other technique known to those skilled in the art. The luminescent layer 24 may be cured by air drying, UV absorption, thermal absorption, condensation addition, thermally driven entanglement, or cross-linking induced by cationic or anionic species.

The phosphorescent or fluorescent ink is preferably formed of a polymeric binder or resin and a phosphorescent pigment, a fluorescent dye, a fluorescent pigment, or a mixture of both, dispersed in a carrier liquid. The carrier liquid may comprise a single solvent or a mixture of solvents. Other additives, such as rheological control agents, antioxidants, surfactants, and biocides, among others, may also be present in the ink.

The polymeric binder of the phosphorescent or fluorescent ink may be any polymer suitable for adhering to the plastic substrate (base layer) 22 or a plastic film (further discussed below) used in the formation of the self-illuminating glazing panel. Examples of polymeric binders or resins include, but are not limited to polycarbonate, acrylic, polyacrylate, polyester, polysulfone, polyurethane, silicone, epoxy, polyamide, polyalkylenes, acrylonitrile-butadiene-styrene (ABS) as well has copolymers, blends, and mixtures thereof. Preferably, the polymeric binder in the phosphorescent or fluorescent ink is substantially similar to the polymeric resin present in any ink or coating used to form an optional functional layer in the self-illuminating glazing panel, as discussed below.

Phosphorescent pigments include, but are not limited to strontium oxide aluminates, sulphides of calcium, strontium, zinc, or barium doped with copper, bismuth, or manganese, and radioisotopes, such as Radium or Tritium. A specific example of a phosphorescent pigment is strontium oxide aluminate available as LumiNova® from Nemoto & Co. Ltd. (Tokyo, Japan).

Suitable fluorescent dyes include, but are not limited to, sodium fluorescein, rhodamine, fluoresceine, resorcinolphthalein, and conjugated derivatives of stilbene and benzimidazole. Fluorescent pigments include, but are not limited to, organic pigments and minerals that absorb short wavelengths and long wavelengths of light. Examples of long wavelength absorbing fluorescent minerals include agate (white-blue), magnesite (white-blue), calcite (red), fluorite (yellow), and scapolite (pink). Examples of short wavelength absorbing fluorescent minerals include ruby (red), halite (red), gypsum (yellow), diamond, and adamite (green). A specific example of an organic fluorescent pigment is the aldazine pigment (yellow) available as Lumogen® Yellow S 0790 from BASF (Germany).

Phosphorescence is a form of photoluminescence stimulated by the absorption of light in the UV-Vis-NIR spectral region. Phosphorescent pigments absorb light at wavelengths represented by this spectral region, which is then remitted slowly over time, typically as photons of longer wavelengths of light. Phosphorescent pigments are known to “glow in the dark” releasing the absorbed light over minutes or hours after the light source has been removed. When phosphorescent pigments are integrated with a self-illuminating glazing panel of a vehicle, the excitation light source may typically be the headlights of other vehicles, as well as streetlights and other light sources external to the vehicle.

The phosphorescent effect is highly dependent upon the selection of the pigments, the light absorption properties of the self-illuminating glazing panel, and the intensity of the light absorbed. The type of pigment selected, preferably, absorbs light in a portion of the spectral region that is substantially different than the portion of the region being effectively filtered or absorbed by the plastic substrate, plastic film, or weatherable layer. For example, polycarbonate is an effective filter of any UV radiation having a wavelength below about 380 nanometers. In addition, the photolytic degradation of polycarbonate upon exposure to UV radiation exhibiting a wavelength of 290 to 340 nanometers, requires the weatherable layer to absorb or reflect these wavelengths of light, thereby, protecting the underlying plastic panel and plastic film. Thus, in this specific case, it would be preferred that the phosphorescent pigments present in the luminescent layer absorb a wavelength of light that is greater than about 380 nanometers.

The luminescent layer may be comprised of a mixture of phosphorescent and fluorescent pigments. In this embodiment, the light absorbed and re-emitted by the fluorescent pigments occurs over a very rapid time frame with respect to the time frame over which light is re-emitted by the phosphorescent pigments. This rapid re-emission of fluorescent light causes the self-illuminating glazing panel to “glow”.

Fluorescence is a form of photoluminescence that occurs on a substantially faster time scale than phosphorescence. In fluorescence, the emitted light is always of a longer wavelength than the excitation or incident light. The emission of fluorescent light continues to occur as long as the external light source is present. If the exciting radiation is stopped, then the occurrence of fluorescence ceases. A more thorough molecular treatment of both phosphorescence and fluorescence is available to those skilled in the art in the form of a Jablonski Energy Diagram. Similar to phosphorescence, the fluorescent effect is highly dependent upon the selection of the pigments, the light absorption properties of the self-illuminating glazing panel, and the intensity of the light absorbed. The fluorescent pigment utilized in the luminescent layer of a self-illuminating panel preferably absorbs light in a portion of the spectral region different from the portion of the region that is filtered or absorbed by the plastic substrate, plastic film, or the weatherable layer.

The use of phosphorescent pigments is preferable over the use of fluorescent pigments due to the associated longer timeframe for emitting light.

An optional functional layer 26 may be placed onto the surface of the luminescent layer 24. This optional functional layer 26 may provide multiple functionality to the self-illuminating glazing panel 18. For example, the functional layer 26 may comprise a decorative layer, such as a black-out or fade-out layer in order to hide the bonding system used to adhere the panel to the vehicle. Other functionalities provided by the optional functional layer 26 may include, but are not be limited to, logos, defrosters or heater grids, antennas, solar control, electroluminescence, conductive films, photochromic films, or electrochromic films. The optional functional layer 26 may cure by air drying, UV absorption, thermal absorption, condensation addition, thermally driven entanglement, or cross-linking induced by cationic or anionic species.

The weatherable layer 28, which protects the self-illuminating glazing panel from environmental elements, such as UV radiation and moisture, may comprise silicones, polyurethanes, acrylics, polyesters, epoxies, and mixtures or copolymers thereof. It will be apparent to one skilled in the art that the weatherable layer 28 may include other suitable materials that impart weatherability to the self-illuminating glazing panel. Weatherable layer 28 may be extruded, cast as thin films, or applied as a discrete coating. The weatherable layer 28 may be a single layer or a combination of multiple sub-layers 27. A specific example of a weatherable layer 28 comprising multiple sub-layers 27 includes a combination of an acrylic primer (SHP401, GE Silicones, Waterford, N.Y.) and a silicone hard-coat (AS4000, GE Silicones). The weatherable layer 28 may further comprise additional additives including colorants (tints), rheological control agents, antioxidants, ultraviolet absorbing (UVA) molecules, and IR absorbing or reflecting pigments, among others. Due to the decreased amount of UV radiation impinging on the surface of the window facing the interior of the car, the weatherable layer 28′ present on the interior side of the self-illuminating glazing panel is optional.

The weatherable layer 28 may be applied by dip coating, flow coating, spray coating, curtain coating, or any other techniques known to those skilled in the art. The thickness of the weatherable layer 28 may range from about 2 micrometers to several mils (1 mil=25.4 micrometers), with about 6 micrometers to 1 mil being preferred. The weatherable layer 28 may cure by air drying, UV absorption, thermal absorption, condensation addition, thermally driven entanglement, or cross-linking induced by cationic or anionic species.

The abrasion resistant layer 29 may comprise a single layer or multiple sub-layers 30. The abrasion resistant layer 29 may be comprised of aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture or blend thereof. Preferably, the abrasion resistant layer 29 is comprised of a composition of SiOₓ or SiOₓC_{y}H_{z} depending upon the amount of carbon and hydrogen atoms that remain in the deposited layer. In this regard, the abrasion resistant layer 29 resembles a “glass-like” coating.

The abrasion resistant layer 29 may be applied by any suitable technique known to those skilled in the art including techniques involving the deposition of a film from reactive species, such as but not limited to those employed in vacuum-assisted deposition processes. Examples of suitable coating processes include, but are not limited to, plasma-enhanced chemical vapor deposition (PECVD), expanding thermal plasma PECVD, plasma polymerization. photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and any known sol-gel coating process. The thickness of the abrasion layer 29 may range from about 1 micrometer to 1 mil with about 3 micrometers to 10 micrometers being preferred. Optionally, a similar abrasion layer 29′ may be applied to the interior of the glazing panel.

The weatherable layer 28 and abrasion resistant layer 29 may be combined to form a layered glazing system. Examples of layered glazing systems, include but are not limited to the acrylic/silicone/“glass-like” systems offered by Exatec LLC (Wixom, Mich.) as Exatec® 500, Exatec® 900, and Exatec® 900vt glazing systems.

Another embodiment of the present invention includes the incorporation of a decorative film as part of the various layers in the self-illuminating glazing panel using film insert molding (FIM) techniques. This decorated film may comprise a plastic film along with the luminescent layer and any optional functional layers. In forming the panel, the decorated film is placed onto tooling of an injection mold with the luminescent and optional functional layers facing away from the surface of the tooling and toward the cavity defined by the mold. A plastic resin is then injected into the mold to encapsulate the luminescent layer and any optional functional layer between the plastic resin and the film.

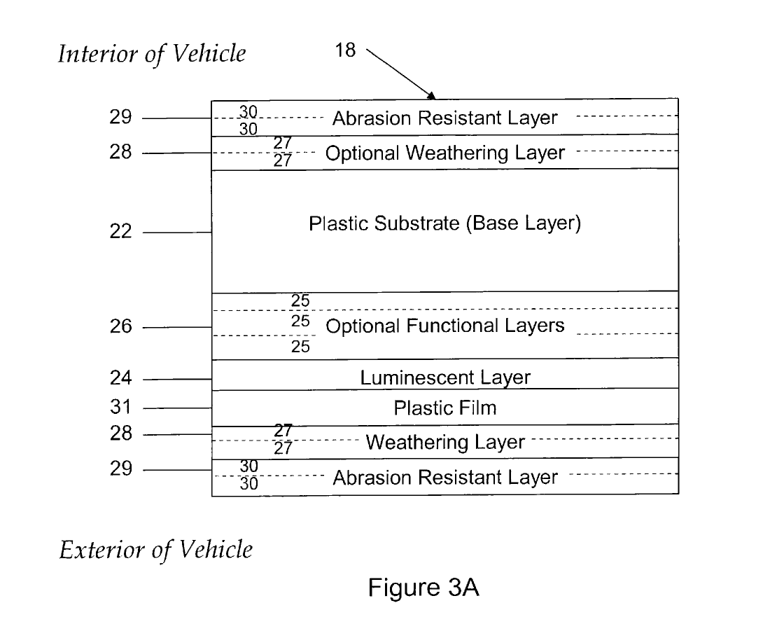

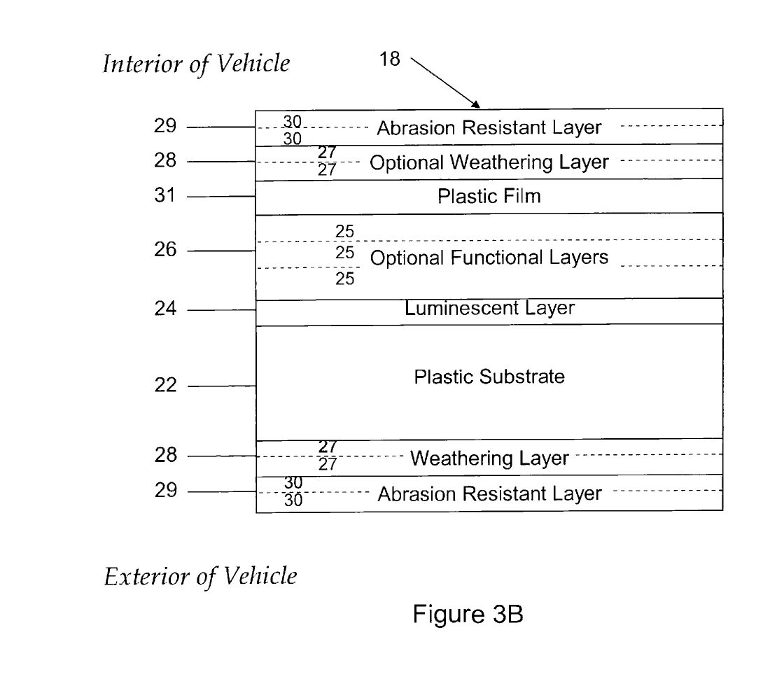

FIG. 3A illustrates a diagrammatic cross sectional view of another embodiment of a self-illuminating glazing panel 18 as provided by the present invention and that incorporates the use of a decorated film. In this embodiment, the self-illuminating glazing panel 18 comprises a plastic film layer 31 and a luminescent layer 24 printed on the plastic film layer 31. An optional functional layer 26 may be printed or deposited on the luminescent layer 24 by any standard technique known to skilled in the art. The plastic substrate 22 is then back molded onto the plastic film. In this embodiment the plastic film is located, relative to the substrate 22, toward the exterior of the vehicle. The subsequent application of a weatherable layer 28 to the plastic film is preferable in order to block the transmission of ultraviolet radiation to the plastic film. The abrasion resistant layer 29 provides an additional degree of surface-hardening, as well as protection from abrasion, moisture, and other external elements. As with the prior embodiments, an additional weatherable layer 28′ and abrasion resistant layer 29′ may be applied to the interior side of the substrate 22.

FIG. 3B illustrates a cross-sectional view of a further embodiment of a self-illuminating glazing panel 18 as provided by the present invention. This embodiment is similar to the embodiment described in FIG. 3A except that in this embodiment the plastic film 30 is located toward the interior of the vehicle 10. In order not to obscure the luminescent layer 24, any optional functional layers 26 are preferably applied to the plastic film 30 prior to the application of the luminescent layer 24 to the film. In this respect, the position of the luminescent layer 24 and any functional layer 26 have been reversed for this embodiment as compared to the embodiment previously described in FIG. 3A. In substantially all other aspects, the embodiment of FIG. 3B is constructed the same as the embodiment of FIG. 3A.

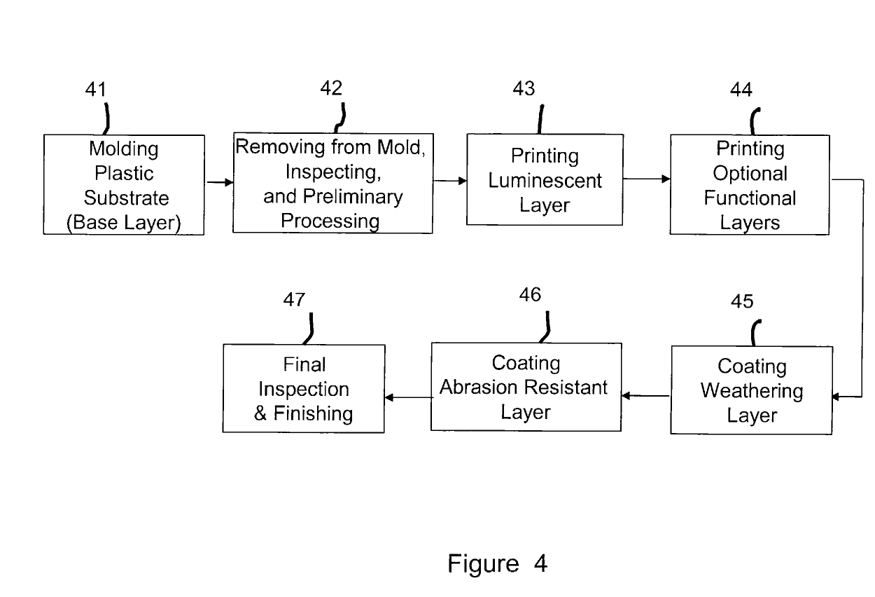

FIG. 4 is a block diagram representation of a process for manufacturing a self illuminating glazing panel 18 according to one embodiment of the present invention. At step 41, a plastic substrate 22 is formed via injection molding of a transparent plastic resin, such as a polycarbonate or acrylic resin. Plastic substrate 22 forms the base layer for the self-illuminating glazing panel 18. At step 42, the plastic substrate 22 is removed from the mold, inspected, and any preliminary processing is carried out such as cleaning, which includes the elimination of any static electrical charges. At step 43, the luminescent layer 24 is printed onto the plastic substrate 22.

In a preferred embodiment, the luminescent layer 24 is printed by a screen printing process. In the screen printing process, a fine mesh screen equipped with a stencil according to the desired shape of the luminescent layer 24, is placed parallel with the plastic substrate 22. The screen is then deposited with luminescent ink, followed by forcing of the luminescent ink through the openings of the stencil on the screen using a squeegee that is drawn across the surface of the screen. After the squeegee passes the stencil region, the tension of the stretched screen along with the off-contact distance between the screen and the plastic substrate 22 allows the screen to separate from the surface of the substrate leaving the luminescent layer 24 deposited onto the surface of the substrate. It will be apparent to those skilled in the art that other techniques such as inkjet printing or mask and spray may also be used for providing the luminescent layer 24 onto the plastic substrate 22.

At step 44, any optional functional layers 26 are applied over the luminescent layer 24. A functional layer 28 can be applied by screen printing, inkjet printing, mask & spray, spray coating, or any other techniques known to those skilled in the art. At step 45, the weatherable layer 28 is applied to the glazing panel. The weatherable layer 28 may be applied by dip coating, flow coating, spray coating, curtain coating, or any other techniques known to those skilled in the art. At step 46, the abrasion layer 29 is applied to the glazing panel. The abrasion layer 29 is applied by any suitable technique known to those skilled in the art, including techniques involving the deposition of a film from a reactive species, e.g., vacuum-assisted deposition processes. At step 47, both a final inspection and finishing of the self-illuminating glazing panel 18 are carried out. The finishing of the self-illuminating glazing panel may include, but need not be limited to, such operations as the sanding or milling of panel edges, the attachment of positioning clips, spacers, or fasteners, the application of an adhesive primer and adhesive, or the cutting of holes for attachments, such as wipers.

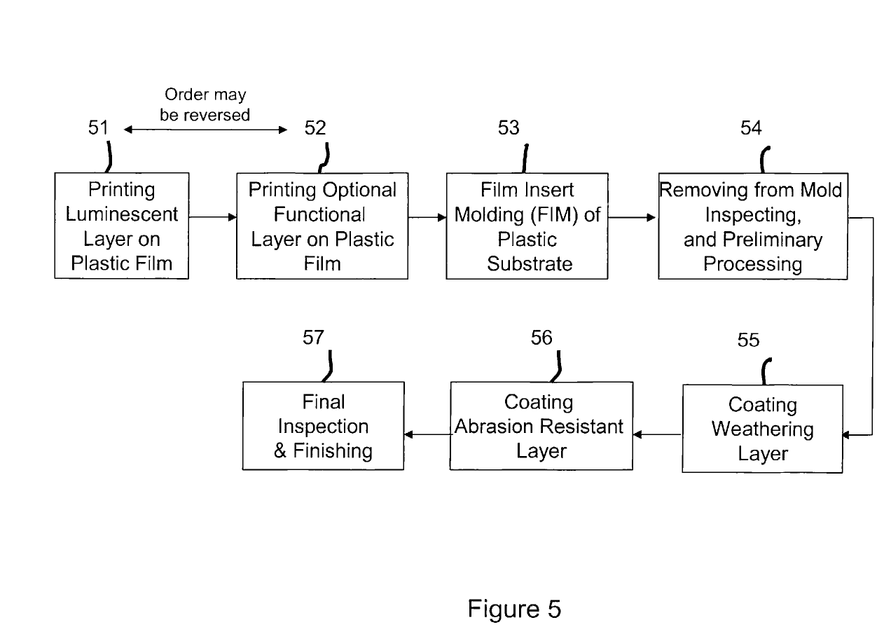

FIG. 5 is a block diagram representation of a process for preparing a self-illuminating glazing panel 18 according to another embodiment of the present invention. At step 51, the luminescent layer 24 is printed onto a plastic film. In a preferred embodiment, the luminescent layer 24 is printed via a screen printing process. It will be apparent to those skilled in the art that other techniques, such as inkjet printing or mask and spray, may also be used for printing the luminescent layer 24 onto the plastic film. At step 52, an optional functional layer 26 is applied over the luminescent layer 24. The optional functional layer 26 can be applied by screen printing, inkjet printing, mask & spray, spray coating, or other techniques known to those skilled in the art. Steps 51 and 52 may be reversed in sequence depending upon if the plastic film faces the exterior of the vehicle as depicted in FIG. 3A or interior of the vehicle as depicted in FIG. 3B.

At step 53, the decorated, plastic film is placed into the cavity of a mold and the plastic substrate 22 is back molded onto the film, thereby encapsulating the luminescent layer 24 and any optional functional layers 36. This molding process is known to those skilled in the art as film insert molding (FIM). At step 54, the molded plastic substrate 22 is removed from the mold, inspected, and any preliminary processing is carried out such as cleaning, which includes the elimination of static electrical charges. At step 55, the weatherable layer 28 is applied to the glazing panel. The weatherable layer 28 may be applied by dip coating, flow coating, spray coating, curtain coating, or any other technique known to those skilled in the art. At step 56, the abrasion resistant layer 29 is applied to the glazing panel. The abrasion resistant layer 29 may be applied by any suitable technique known to those skilled in the art including but not limited to techniques involving the deposition of a film from a reactive species, e.g., a vacuum-assisted deposition process. At step 57, both a final inspection and finishing of the self-illuminating glazing panel 18 are carried out.

In as much as the foregoing disclosure is intended to enable one skilled in the pertinent art to practice the present invention, it should not be construed to be limited thereby, but should be construed to include such aforementioned obvious variations and be limited only by the spirit and scope of the following claims.

1. A self-illuminating glazing panel suitable for use in an automotive vehicle, the glazing panel comprising:
a plastic substrate;
a luminescent layer deposited over the plastic substrate;
at least one weatherable layer capable of protecting the glazing panel from environmental elements; and
at least one abrasion resistant layer deposited over the weatherable layer.

2. The self-illuminating glazing panel of claim 1 further comprising a functional layer located between the plastic substrate and the abrasion resistant layer.

3. The self-illuminating glazing panel of claim 1 wherein the plastic substrate is one selected from the group of polycarbonate, acrylic, polyacrylate, polyester, polysulfone, polyurethane, silicone, epoxy, polyamide, polyalkylenes, acrylonitrile-butadiene-styrene, and copolymers, blends, or mixtures thereof.

4. The self-illuminating glazing panel of claim 1 wherein the weatherable layer comprises one selected from the group of silicones, polyurethanes, acrylics, polyesters, epoxies, and mixtures or copolymers thereof.

5. The self-illuminating glazing panel of claim 1 wherein the plastic substrate is one of transparent, translucent, opaque or a combination thereof.

6. The self-illuminating glazing panel of claim 1 wherein the luminescent layer is one of phosphorescent material, fluorescent material, or combination thereof.

7. The self-illuminating glazing panel of claim 6 wherein the luminescent layer includes a polymeric resin or binder and one of a phosphorescent pigment, a fluorescent pigment, a fluorescent dye, or mixtures thereof, dispersed in a carrier medium.

8. The self-illuminating glazing panel of claim 7 further comprising a functional layer and wherein the polymeric resin or binder is substantially similar to a polymeric resin present in the functional layer.

9. The self-illuminating glazing panel of claim 1 wherein the abrasion layer comprises one selected from a group of aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture or blend thereof.

10. The self-illuminating glazing panel of claim 1 further comprising a functional layer including a functionality selected from a group of black-outs, fade-outs, logos, defrosters, antennas, solar control, electroluminescence, conductive films, photochromic films, and electrochromic films.

11. The self-illuminating glazing panel of claim 1 wherein the illuminescent layer absorbs light in a portion of the spectral region that is not blocked or filtered by the plastic substrate and weatherable layer.

12. The self-illuminating glazing panel of claim 1 wherein the illuminescent layer absorbs light having a wavelength greater than about 380 nanometers.

13. A method for manufacturing a self-illuminating glazing panel suitable for use in an automotive vehicle, the method comprising:
forming a self-illuminating plastic substrate;
depositing at least one weatherable layer onto the surface of the self-illuminating plastic substrate, the weatherable layer capable of protecting the self-illuminating plastic substrate from environmental elements; and
depositing at least one abrasion resistant layer onto the weatherable layer.

14. The method of manufacturing the self-illuminating glazing panel of claim 13 wherein the step of forming the self-illuminating plastic substrate further comprises the steps of:
molding a plastic substrate from a polymeric resin; and
printing a luminescent ink on the molded plastic substrate.

15. The method of manufacturing the self-illuminating glazing panel of claim 14 wherein the luminescent ink is printed using one of the methods selected from the group of screen printing, ink jet printing, and mask and spray.

16. The method of manufacturing the self-illuminating glazing panel of claim 14 further comprising the step of curing the luminescent ink using one method selected from the group of air drying, UV absorption, thermal absorption, condensation addition, thermally driven entanglement, and cross-linking induced by cationic or anionic species.

17. The method of manufacturing the self-illuminating glazing panel of claim 13 wherein the weatherable layer is provided as one of an extruded layer, cast thin film and a discrete coating

18. The method of manufacturing the self-illuminating glazing panel of claim 17 wherein the discrete coating is applied using a technique selected from the group of dip coating, flow coating, spray coating and curtain coating.

19. The method of manufacturing the self-illuminating glazing panel of claim 13 wherein the abrasion resistant layer is deposited using one of the methods selected from the group of plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and a sol-gel coating process.

20. The method of manufacturing the self-illuminating glazing panel of claim 13 further comprising the step of providing a functional layer on a luminescent layer.

21. The method of manufacturing the self-illuminating glazing panel of claim 13 wherein the step of forming the self-illuminating plastic substrate further comprises the steps of:
printing a luminescent ink on a plastic film;
placing the film within the cavity of a mold; and
injection molding the plastic substrate so that luminescent ink is encapsulated between the plastic film and substrate.

22. The method of manufacturing the self-illuminating glazing panel of claim 17 wherein the luminescent ink is printed using one of the methods selected form the group of screen printing, ink jet printing, and mask and spray.

23. The method of manufacturing the self-illuminating glazing panel of claim 17 further comprising the step of curing the luminescent ink by one of the methods selected from the group of air drying, UV absorption, thermal absorption, condensation addition, thermally driven entanglement, and cross-linking induced by cationic or anionic species.

24. The method of manufacturing the self-illuminating glazing panel of claim 21 further comprising the step of providing a functional layer deposed on the plastic film.
